(19) United States
(12) Patent Application Publication
(10) Pub. No.: US 2026/0132623 A1
(43) Pub. Date: May 14, 2026

(54) QUICKLY-MOUNTED CEILING CURTAIN

(71) Applicant: NINGBO LIYANG NEW MATERIAL COMPANY LIMITED, Ningbo (CN)

(72) Inventor: Chun JIANG, Ningbo (CN)

(21) Appl. No.: 19/292,149

(22) Filed: Aug. 6, 2025

(30) Foreign Application Priority Data
Nov. 11, 2024 (CN) 202422745265.6

(51) Int. Cl. E04B 9/22; A47H 1/18

(52) U.S. Cl. CPC E04B 9/225; A47H 1/18

(57) ABSTRACT

The present disclosure provides a quickly-mounted ceiling curtain, which comprises a frame body formed by connecting a top beam, a bottom beam and two side beams. At least one end of the top beam is provided with a holing-free mounting member for supporting the frame body on a mounting position of a building. At least one end of the bottom beam is provided with a holing-free mounting member for supporting the frame body on the mounting position of the building. With the holing-free mounting members provided on the top beam and the bottom beam of the frame body, the ceiling curtain is supported on the mounting position of the building, realizing quick and holing-free mounting of the ceiling curtain without drilling holes with auxiliary tools, and thus saving time and labor and improving mounting efficiency.

This application is based upon and claims priority to Chinese Patent Application No. 202422745265.6, filed on Nov. 11^{th}, 2024, the entire contents of which are incorporated herein by reference.

### TECHNICAL FIELD

The present disclosure relates to the technical field of ceiling curtains and in particular to a quickly-mounted ceiling curtain.

### BACKGROUND

The ceiling curtains are sun-shading and daylighting products applied to top surfaces and facades of buildings to directly and efficiently improve sunlight illumination and control photo-thermal radiation to enter indoors through top-surface daylighting parts, thereby achieving indoor thermal environment. The ceiling curtains usually comprise a rectangular frame, which is composed of a top beam, a bottom beam and two side beams. During mounting, most of them are mounted by drilling holes with auxiliary tools and fixing with screws to the mounting positions of the buildings. Drilling holes will not only damage the walls and affect the aesthetics but also produce dusts difficult to clean, leading to time-consuming and labor-consuming mounting and low efficiency.

### SUMMARY

For the above situations in the prior arts, the technical problem to be solved by the present disclosure is to provide a quickly-mounted ceiling curtain, which can be quickly mounted with less time and labor but with higher efficiency.

In order to solve the above technical problem, the present disclosure employs the following technical solution: there is provided a quickly-mounted ceiling curtain, which comprises a frame body formed by connecting a top beam, a bottom beam and two side beams. At least one end of the top beam is provided with a holing-free mounting member for supporting the frame body on a mounting position of a building. At least one end of the bottom beam is provided with a holing-free mounting member for supporting the frame body on the mounting position of the building.

Furthermore, the holing-free mounting member is mounted on one end of the top beam and the other end of the top beam is provided with a corner box; the holing-free mounting member is mounted on one end of the bottom beam and the other end of the bottom beam is provided with a corner box.

Furthermore, a first connection portion for inserting into the top beam or the bottom beam and a second connection portion for inserting into the side beam are disposed on the corner box. The first connection portion and the second connection portion are perpendicular to each other.

Furthermore, a detachable cover surface is disposed on the corner box, and a first extension edge and a second extension edge perpendicular to each other are disposed on an outer side of the corner box. A round hole is opened on each of the first extension edge and the second extension edge.

Furthermore, the holing-free mounting member comprises a connection seat, a moving abutting block, a driving piece, a transmission piece and a locking piece. The connection seat is provided with a first insertion portion for inserting into the top beam or the bottom beam, and a second insertion portion for inserting into the side beam. A cavity is disposed in the connection seat and the moving abutting block is in slide cooperation with the cavity. A linkage shaft is disposed on the moving abutting block and the linkage shaft penetrates through the cavity and is exposed at an outer end of the connection seat and connected with a screw and a washer. The driving piece is mounted inside the cavity and at least one end of the driving piece is in communication with the outside of the connection seat. The transmission piece is sleeved on the linkage shaft and linkage-assembled with the driving piece in a perpendicular crossing way. The locking piece is thread-sleeved on the transmission piece to limit the axial movement of the moving abutting block.

Furthermore, a first elastic piece is sleeved on the linkage shaft, and both ends of the first elastic piece are respectively abutted against an end of the transmission piece and the moving abutting block. In a natural state, the first elastic piece is in a compressed state so as to push the moving abutting block to move out of the cavity of the connection seat. The washer at the end of the linkage shaft is in blocking connection with an outer wall of the connection seat.

Furthermore, the driving piece is a worm rod which is disposed at a side away from the moving abutting block inside the cavity. The transmission piece comprises a worm gear portion in cooperation with the worm rod and a screw rod portion in cooperation with the locking piece. A through hole in communication with the cavity is opened on the connection seat for the ends of the worm rod to communicate with the outside.

Furthermore, the worm gear portion is linked with the screw rod portion through tooth surface meshing. A second elastic piece is sleeved on the linkage shaft, and both ends of the second elastic piece are respectively abutted against the worm gear portion and an inner bottom surface of the cavity. In a natural state, the second elastic piece is in a compressed state to push the worm gear portion to mesh with the screw rod portion.

Furthermore, an insertion hole corresponding to the through hole is disposed on each of the top beam and the bottom beam.

Furthermore, a detachable decorative cover is disposed on the connection seat. A third extension edge and a fourth extension edge perpendicular to each other are disposed on an outer side of the connection seat. A round hole is disposed on each of the third extension edge and the fourth extension edge.

Compared with the prior arts, the present disclosure has the following advantages: with the holing-free mounting members provided on the top beam and the bottom beam of the frame body, the ceiling curtain is supported on the mounting position of the building, realizing quick and holing-free mounting of the ceiling curtain without drilling holes with auxiliary tools, and thus saving time and labor and improving mounting efficiency.

### BRIEF DESCRIPTION OF THE DRAWINGS

FIG. 1 is a structural schematic diagram of the present disclosure.

FIG. 2 is an exploded view of the present disclosure.

FIG. 3 is an exploded view of a corner box of the present disclosure.

FIG. 4 is an exploded view of a holing-free mounting member of the present disclosure.

FIG. 5 is a structural schematic diagram of a connection seat of the present disclosure.

The numerals of the drawings are described below: 1. top beam, 2. bottom beam, 3. side beam, 4. holing-free mounting member, 4.1 connection seat, 4.1.1 first insertion portion, 4.1.2 second insertion portion, 4.1.3 cavity, 4.1.4 through hole, 4.1.5 decorative cover, 4.1.6 third extension edge, 4.1.7 fourth extension edge, 4.2 moving abutting block, 4.2.1 linkage shaft, 4.3 worm rod, 4.4 worm gear portion, 4.5 screw rod portion, 4.6 locking piece, 4.7 first elastic piece, 4.8 second elastic piece, 5. corner box, 5.1 first connection portion, 5.2 second connection portion, 5.3 cover surface, 5.4 first extension edge, 5.5 second extension edge, 6. insertion hole.

### DETAILED DESCRIPTIONS OF EMBODIMENTS

The present invention will be further detailed below in combination with specific embodiments.

In the descriptions of the present invention, it is understood that orientation or positional relationship indicated by the terms such as “central”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, and “circumferential” is used only for ease of descriptions and simplification of descriptions and does not indicate or imply that the indicated devices or elements must have a particular orientation, or be constructed or operated in a particular orientation. Therefore, such terms shall not be understood as limiting of the present invention.

Further, the terms “first” and “second” are used for descriptions only and shall not be understood as indicating or implying relative importance or implicitly indicating the number of the indicated features. As a result, the features defined by “first” and “second” may explicitly or implicitly include at least one feature. In the descriptions of the present invention, the meaning of “several” refers to at least two, for example, two or three or the like, unless otherwise clearly stated.

In the present invention, unless otherwise clearly stated or defined, the terms “mount”, “connect”, “couple”, and “fix” and the like shall be understood in a broad sense, for example, may be fixed connection, or detachable connection, or formed into one piece; or may be mechanical connection, or electrical connection; or direct connection or indirect connection through an intermediate medium, or may be internal communication between two elements or mutual interaction of two elements, unless otherwise stated. Those skilled in the art may understand the specific meanings of the above terms in the present invention according to actual situations.

In the present invention, unless otherwise clearly stated or defined, the first feature being “on” or “below” the second feature refers to that the first feature and the second feature are in direct contact, or the first feature and the second feature are in indirect contact through an intermediate medium. Furthermore, the first feature being “above” or “on” the second feature refers to that the first feature is exactly above or obliquely above the second feature, or only refers to that the first feature has a higher horizontal height than the second feature. The first feature being “under” or “below” the second feature refers to that the first feature is exactly under or obliquely below the second feature, or only refers to that the first feature has a smaller horizontal height than the second feature.

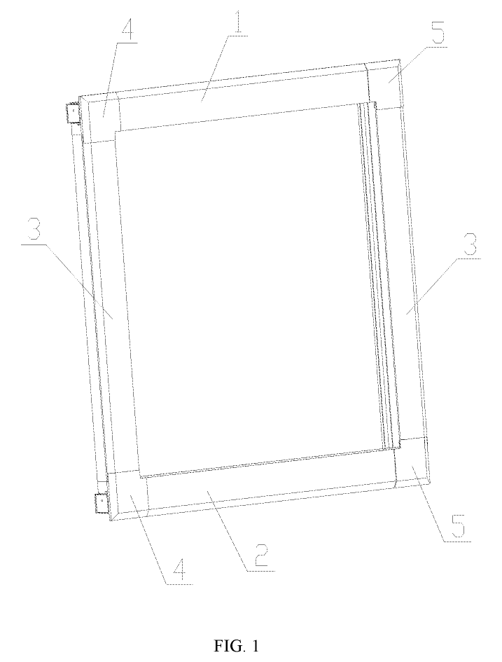

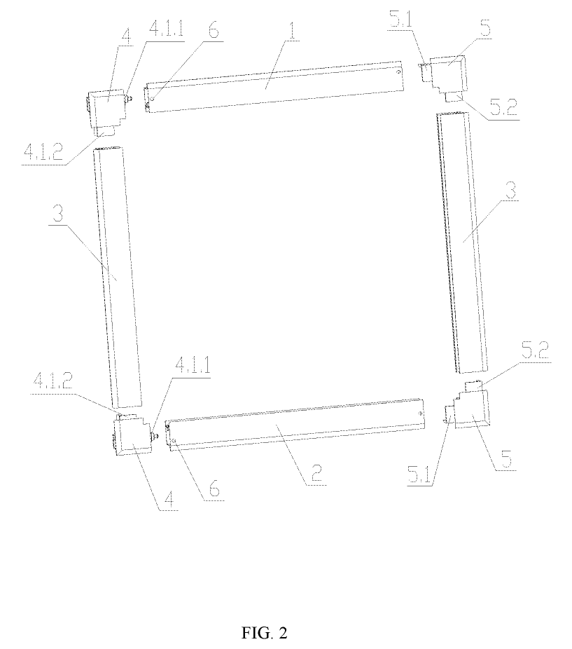

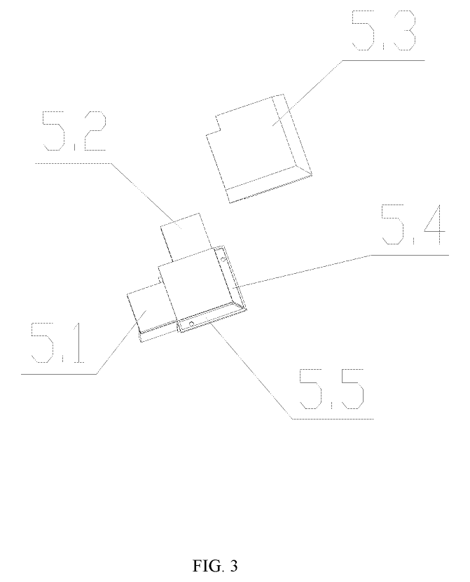

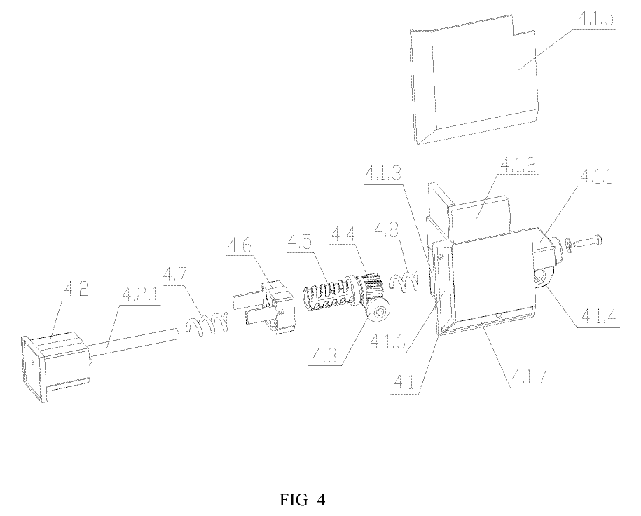

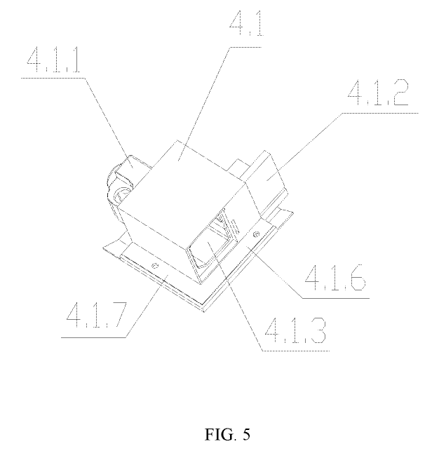

As shown in FIGS. 1 to 5, there is provided a quickly-mounted ceiling curtain, which comprises a frame body formed by connecting a top beam 1, a bottom beam 2 and two side beams 3. At least one end of the top beam 1 is provided with a holing-free mounting member 4 for supporting the frame body on a mounting position of a building. At least one end of the bottom beam 2 is provided with a holing-free mounting member 4 for supporting the frame body on the mounting position of the building.

In the present disclosure, with the holing-free mounting members 4 provided on the top beam 1 and the bottom beam 2 of the frame body, the ceiling curtain is supported on the mounting position of the building, realizing quick and holing-free mounting of the ceiling curtain without drilling holes with auxiliary tools, and thus saving time and labor and improving mounting efficiency.

The holing-free mounting member 4 can be mounted on one or two ends of each of the top beam 1 and the bottom beam 2. Preferably, the holing-free mounting member 4 is mounted on one end of the top beam 1 and the other end of the top beam 1 is provided with a corner box 5; the holing-free mounting member 4 is mounted on one end of the bottom beam 2 and the other end of the bottom beam 2 is provided with a corner box 5.

A first connection portion 5.1 for inserting into the top beam 1 or the bottom beam 2 and a second connection portion 5.2 for inserting into the side beam 3 are disposed on the corner box 5. The first connection portion 5.1 and the second connection portion 5.2 are perpendicular to each other, facilitating convenient and quick mounting.

A detachable cover surface 5.3 is disposed on the corner box 5, and a first extension edge 5.4 and a second extension edge 5.5 perpendicular to each other are disposed on an outer side of the corner box 5. A round hole is opened on each of the first extension edge 5.4 and the second extension edge 5.5. In addition to achieving the aesthetic effect, the cover surface 5.3 can also be mounted detachably so that different colors can be selected based on the preference of the users, making the decoration more flexible and the selection richer.

The holing-free mounting member 4 comprises a connection seat 4.1, a moving abutting block 4.2, a driving piece, a transmission piece and a locking piece 4.6. The connection seat 4.1 is provided with a first insertion portion 4.1.1 for inserting into the top beam 1 or the bottom beam 2, and a second insertion portion 4.1.2 for inserting into the side beam 3. The first insertion portion 4.1.1 and the second insertion portion 4.1.2 help the holing-free mounting member 4 to be quickly assembled with the top beam 1, the bottom beam 2 and the side beams 3, making the assembling and disassembling easy. A cavity 4.1.3 is disposed in the connection seat 4.1 and the moving abutting block 4.2 is in slide cooperation with the cavity 4.1.3. A linkage shaft 4.2.1 is disposed on the moving abutting block 4.2 and the linkage shaft 4.2.1 penetrates through the cavity 4.1.3 and is exposed at an outer end of the connection seat 4.1 and connected with a screw and a washer. The driving piece is mounted inside the cavity 4.1.3 and at least one end of the driving piece is in communication with the outside of the connection seat 4.1. The transmission piece is sleeved on the linkage shaft 4.2.1 and linkage-assembled with the driving piece in a perpendicular crossing way. The locking piece 4.6 is thread-sleeved on the transmission piece to limit the axial movement of the moving abutting block 4.2. A first elastic piece 4.7 is sleeved on the linkage shaft 4.2.1, and both ends of the first elastic piece 4.7 are respectively abutted against an end of the transmission piece and the moving abutting block 4.2. In a natural state, the first elastic piece 4.7 is in a compressed state so as to push the moving abutting block 4.2 to move out of the cavity 4.1.3 of the connection seat 4.1. The washer at the end of the linkage shaft 4.2.1 is in blocking connection with an outer wall of the connection seat 4.1. The driving piece is a worm rod 4.3 which is disposed at a side away from the moving abutting block 4.2 inside the cavity 4.1.3. The transmission piece comprises a worm gear portion 4.4 in cooperation with the worm rod 4.3 and a screw rod portion 4.5 in cooperation with the locking piece 4.6. An inner thread in thread cooperation with the screw rod portion 4.5 is disposed on the locking piece 4.6. By thread cooperation, the screw rod portion 4.5 rotates to push the locking piece 4.6 to perform axial reciprocating movement along the linkage shaft 4.2.1, thereby locking or unlocking the moving abutting block 4.2. A through hole 4.1.4 in communication with the cavity 4.1.3 is opened on the connection seat 4.1 for the ends of the worm rod 4.3 to communicate with the outside. An insertion hole 6 corresponding to the through hole 4.1.4 is disposed on each of the top beam 1 and the bottom beam 2. The worm gear portion 4.4 is linked with the screw rod portion 4.5 through tooth surface meshing. A second elastic piece 4.8 is sleeved on the linkage shaft 4.2.1, and both ends of the second elastic piece 4.8 are respectively abutted against the worm gear portion 4.4 and an inner bottom surface of the cavity 4.1.3. In a natural state, the second elastic piece 4.8 is in a compressed state to push the worm gear portion 4.4 to mesh with the screw rod portion 4.5. Since the worm gear portion 4.4 is linked with the screw rod portion 4.5 through tooth surface meshing, the worm gear portion 4.4 can drive the screw rod portion 4.5 under the elastic push of the second elastic piece 4.8. When the twisting force is greater than the elastic force, the worm gear portion 4.4 reversely pushes the second elastic piece 4.8 to skip teeth and restore to meshing with the screw rod portion 4.5 in time under the elastic force. When tooth skip occurs, it indicates that the screw rod portion 4.5 already pushes the locking piece 4.6 to lock the moving abutting block 4.2 so that the moving abutting block 4.2 can be tightly abutted against the mounting wall surface, without continuing twisting the worm rod 4.3 to drive the worm gear portion 4.4 to rotate, thereby avoiding the part damage of over-twisting. Preferably, the first elastic piece 4.7 and the second elastic piece 4.8 both are springs. Furthermore, the end of the moving abutting block 4.2 is provided with an anti-slip pad to increase a frictional force, making the abutting of the moving abutting block 4.2 against the mounting wall surface more stable.

A detachable decorative cover 4.1.5 is disposed on the connection seat 4.1. A third extension edge 4.1.6 and a fourth extension edge 4.1.7 perpendicular to each other are disposed on an outer side of the connection seat 4.1. A round hole is disposed on each of the third extension edge 4.1.6 and the fourth extension edge 4.1.7. In addition to achieving the aesthetic effect, the decorative cover 4.1.5 can also be detachably mounted so that different colors can be selected based on the preference of the users, making the decoration more flexible and the selection richer.

During mounting, the ceiling curtain is first pre-positioned on the mounting position of the building, and the pre-positioning mounting is carried out by pushing the moving abutting block 4.2 outwardly by the elastic force of the first elastic piece 4.7. Then, with an external tool, the worm rod 4.3 is penetrated through the insertion hole 6 and the through hole 4.1.4 and then twisted. The worm rod 4.3 drives the rotation of the worm gear portion 4.4, and the worm gear portion 4.4 drives the rotation of the screw rod portion 4.5 and then the screw rod portion 4.5 pushes the locking piece 4.6 to move toward the moving abutting block 4.2 until the locking piece 4.6 abuts and locks the moving abutting block 4.2, preventing elastic movement of the moving abutting block 4.2 and realizing holing-free mounting. At this time, if the worm rod 4.3 is further twisted, tooth skip may occur between the worm gear portion 4.4 and the screw rod portion 4.5, thereby achieving protection against the part damage of over-twisting. The whole mounting process requires no holing with auxiliary tools, saving time and labor, achieving fast convenient mounting and increasing mounting efficiency.

The materials, reagents and experimental equipment involved in the embodiments of the present disclosure are all commercially-available products in the field of ceiling curtains, unless otherwise stated.

Finally, it is to be pointed out that the above embodiments are merely used to describe the technical solution of the present disclosure rather than limit the present disclosure. Although detailed descriptions are made to the present disclosure by referring to the preceding embodiments, those skilled in the art should understand that the technical solutions recorded in the above embodiments may be modified or part of technical features thereof may be equivalently substituted. Such modifications or substitutions will not cause the essences of the corresponding technical solutions to depart from the spirits and scopes of the technical solutions of various embodiments of the present disclosure.

1. A quickly-mounted ceiling curtain, which comprises a frame body, wherein the frame body is formed by connecting a top beam (1), a bottom beam (2) and two side beam (3)s; at least one end of the top beam (1) is provided with a holing-free mounting member (4) for supporting the frame body on a mounting position of a building; at least one end of the bottom beam (2) is provided with a holing-free mounting member (4) for supporting the frame body on the mounting position of the building.

2. The quickly-mounted ceiling curtain of claim 1, wherein a holing-free mounting member (4) is mounted on one end of the top beam (1) and the other end of the top beam (1) is provided with a corner box (5); the holing-free mounting member (4) is mounted on one end of the bottom beam (2) and the other end of the bottom beam (2) is provided with a corner box (5).

3. The quickly-mounted ceiling curtain of claim 2, wherein a first connection portion (5.1) for inserting into the top beam (1) or the bottom beam (2) and a second connection portion (5.2) for inserting into the side beam (3) are disposed on the corner box (5); the first connection portion (5.1) and the second connection portion (5.2) are perpendicular to each other.

4. The quickly-mounted ceiling curtain of claim 3, wherein a detachable cover surface (5.3) is disposed on the corner box (5), and a first extension edge (5.4) and a second extension edge (5.5) perpendicular to each other are disposed on an outer side of the corner box (5); a round hole is opened on each of the first extension edge (5.4) and the second extension edge (5.5).

5. The quickly-mounted ceiling curtain of any one claim of claims claim 1, wherein the holing-free mounting member (4) comprises a connection seat (4.1), a moving abutting block (4.2), a driving piece, a transmission piece and a locking piece (4.6); the connection seat (4.1) is provided with a first insertion portion (4.1.1) for inserting into the top beam (1) or the bottom beam (2), and a second insertion portion (4.1.2) for inserting into the side beam (3); a cavity (4.1.3) is disposed in the connection seat (4.1) and the moving abutting block (4.2) is in slide cooperation with the cavity (4.1.3); a linkage shaft (4.2.1) is disposed on the moving abutting block (4.2) and the linkage shaft (4.2.1) penetrates through the cavity (4.1.3) and is exposed at an outer end of the connection seat (4.1) and connected with a screw and a washer; the driving piece is mounted inside the cavity (4.1.3) and at least one end of the driving piece is in communication with the outside of the connection seat (4.1); the transmission piece is sleeved on the linkage shaft (4.2.1) and linkage-assembled with the driving piece in a perpendicular crossing way; the locking piece (4.6) is thread-sleeved on the transmission piece to limit the axial movement of the moving abutting block (4.2).

6. The quickly-mounted ceiling curtain of claim 5, wherein a first elastic piece (4.7) is sleeved on the linkage shaft (4.2.1), and both ends of the first elastic piece (4.7) are respectively abutted against an end of the transmission piece and the moving abutting block (4.2); in a natural state, the first elastic piece (4.7) is in a compressed state so as to push the moving abutting block (4.2) to move out of the cavity (4.1.3) of the connection seat (4.1); the washer at the end of the linkage shaft (4.2.1) is in blocking connection with an outer wall of the connection seat (4.1).

7. The quickly-mounted ceiling curtain of claim 5, wherein the driving piece is a worm rod (4.3) which is disposed at a side away from the moving abutting block (4.2) inside the cavity (4.1.3); the transmission piece comprises a worm gear portion (4.4) in cooperation with the worm rod (4.3) and a screw rod portion (4.5) in cooperation with the locking piece (4.6); a through hole (4.1.4) in communication with the cavity (4.1.3) is opened on the connection seat (4.1) for the ends of the worm rod (4.3) to communicate with the outside.

8. The quickly-mounted ceiling curtain of claim 7, wherein the worm gear portion (4.4) is linked with the screw rod portion (4.5) through tooth surface meshing; a second elastic piece (4.8) is sleeved on the linkage shaft (4.2.1), and both ends of the second elastic piece (4.8) are respectively abutted against the worm gear portion (4.4) and an inner bottom surface of the cavity (4.1.3); in a natural state, the second elastic piece (4.8) is in a compressed state to push the worm gear portion (4.4) to mesh with the screw rod portion (4.5).

9. The quickly-mounted ceiling curtain of claim 7, wherein an insertion hole (6) corresponding to the through hole (4.1.4) is disposed on each of the top beam (1) and the bottom beam (2).

10. The quickly-mounted ceiling curtain of claim 5, wherein a detachable decorative cover (4.1.5) is disposed on the connection seat (4.1); a third extension edge (4.1.6) and a fourth extension edge (4.1.7) perpendicular to each other are disposed on an outer side of the connection seat (4.1); a round hole is disposed on each of the third extension edge (4.1.6) and the fourth extension edge (4.1.7).
